(19) United States
(12) Patent Application Publication
(10) Pub. No.: US 2013/0060434 A1
(43) Pub. Date: Mar. 7, 2013

(54) VEHICLE GEAR-SHIFTING CONTROL APPARATUS

(71) Applicants: Yuta Kiuchi, Hamamatsu-shi (JP); Hiroshi Kamatsuke, Hamamatsu-shi (JP)

(72) Inventors: Yuta Kiuchi, Hamamatsu-shi (JP); Hiroshi Kamatsuke, Hamamatsu-shi (JP)

(73) Assignee: SUZUKI MOTOR CORPORATION, Hamamatsu-shi, Shizuoka (JP)

(21) Appl. No.: 13/698,428

(22) PCT Filed: May 16, 2011
(86) PCT No.: PCT/JP2011/061238

§ 371 Date: Nov. 16, 2012

(30) Foreign Application Priority Data
May 17, 2010 (JP) 2010-113068

(51) Int. Cl. B60W 30/14

(52) U.S. Cl. 701/56

(57) ABSTRACT

Disclosed is a vehicle gear-shifting control apparatus (1) performing cruise control which automatically controls output to basically maintain a set vehicle speed set based on a human operation and enables temporary acceleration based on an accelerator pedal operation, the vehicle gear-shifting control apparatus having: a plurality of shift maps to which a priority ranking is set, the shift maps including a cruise shift map used at a time of cruise control and a shift map used at a time of normal traveling; and a plurality of patterns in which the priority rankings of the plurality of shift maps are different from each other, wherein, during traveling, the pattern is selectively changed based on an accelerator pedal operation humanly operated.

### TECHNICAL FIELD

The present invention relates to a vehicle gear-shifting control apparatus, particularly relates to a vehicle gear-shifting control apparatus capable of switching a shift map so that gear-shifting (change of shift speed or gear-shift ratio) based on an accelerator operation of a cruise controlled vehicle becomes easy to be performed.

### BACKGROUND ART

Gear-shifting of an automatic transmission mounted on a vehicle is performed by a gear-shifting control apparatus. Inside the gear-shifting control apparatus, timings at which gear-shifting is performed are set in advance per values of two parameters of an accelerator pedal opening degree (or throttle valve opening degree) and vehicle information, which are called shift maps. The gear-shifting control apparatus is provided with several shift maps so that gear-shifting suitable for a vehicle traveling state can be performed, and switches the shift map in correspondence with situations.

Further, some gear-shifting control apparatuses include cruise control systems to perform constant-speed traveling of vehicles at predetermined vehicle speeds. The cruise control system enables high-speed cruising, and executes cruise control to aid traveling of a vehicle by setting a set speed by means of a human switching operation during actual traveling under a sufficient cruise control execution condition (for example, a speed condition of being equal to or more than a minimum speed of a top shift speed (top gear) is fulfilled) which enables constant-speed traveling and by automatically adjusting engine output to maintain the set speed. According to the cruise control, a driver only have to concentrate on a steering operation and an effort to maintain a traveling speed is reduced, and thus fatigue due to driving can be reduced.

Besides, cruise control, while permitting temporary acceleration by an accelerator pedal operation in order to keep a good relationship with other traffic, enables return to the set speed again by a set back operation thereafter of the accelerator pedal to continue constant-speed traveling, or cancellation of the constant-speed traveling set by a human operation of a switch or an operation of a brake pedal.

The gear-shifting control apparatus is provided with a shift map (hereinafter, referred to as a “cruise shift map”) for cruising, and during cruise control, gear-shifting is performed by using this cruise shift map. During conventional cruise control, in a case that a driver has an acceleration intention to outrun a preceding vehicle or the like, acceleration is done by a switch operation or pressing of an accelerator pedal, and after outrunning the preceding vehicle, a switch operation or setting back of the accelerator pedal is performed.

In some conventional gear-shifting control apparatuses, for example, as disclosed in Patent Literature 1, cruise control and gear-shift ratio control of continuously variable transmissions have cooperativeness therebetween, and engine load amounts and gear-shift ratios are controlled when disturbances enter during cruise control, so that disturbance settling abilities are heightened.

Further, some conventional gear-shifting control apparatuses have, as disclosed in Patent Literature 2, for example, systems detecting relative driver thrust intentions as signals representing drivers' intentions and setting target engine torques and target transmission gear-shift ratios considering the relative driver thrust intentions.

### CITATION LIST

### Patent Literature

Patent Literature 1: Japanese Patent No. 2846754
Patent Literature 2: Japanese National Publication of International Patent Application No. 2005-508788

### SUMMARY OF INVENTION

### Technical Problem

Incidentally, if a driver has an acceleration intention during cruise control as described above, a gear-shifting control apparatus performs acceleration by a switch operation or pressing of an accelerator pedal, and after outrunning a preceding vehicle a switch is operated or the accelerator pedal is set back.

During a sequence of above, an automatic transmission performs gear-shifting based on a cruise shift map, but generally the cruise shift map is set to travel at a top shift speed, and setting is such that kick-down (shift down) based on the accelerator pedal operation is hard to be performed.

As stated above, since kick-down is harder to be performed during cruise control than during traveling in an off state of the cruise control, the kick-down takes time despite the driver's acceleration intention, and there is a problem that the driver senses small acceleration feeling. Moreover, since kick-down is hard to be performed, there is a problem that traveling is done while a driving force is not obtained compared with a case of traveling at a lower shift speed.

An object of the present invention is to enable optimum gear-shifting control in correspondence with a traveling state and to improve drivability during cruise control execution.

### Solution to Problem

A vehicle gear-shifting control apparatus of the present invention is the vehicle gear-shifting control apparatus performing cruise control which automatically controls output to basically maintain a set vehicle speed set based on a human operation and enables temporary acceleration based on an accelerator pedal operation, and is characterized in that the vehicle gear-shifting control apparatus has: a plurality of shift maps to which a priority ranking is set, the shift maps including a cruise shift map used at a time of cruise control and a shift map used at a time of normal traveling; and a plurality of patterns in which the priority rankings of the plurality of shift maps are different from each other, wherein, during traveling, the pattern is selectively changed based on an accelerator pedal operation humanly operated.

Further, the vehicle gear-shifting control apparatus of the present invention is also characterized in that at a time of selective change of the pattern, the pattern is selectively changed based on facts that the cruise shift map is in use and that the accelerator pedal operation amount is increased from a predetermined judgment operation amount. On this occasion, the judgment operation amounts at times of performing increase judgment and decrease judgment of the acceleration pedal operation can be each set in correspondence with a vehicle speed.

Further, the vehicle gear-shifting control apparatus of the present invention is also characterized in that at a time of selective change of the pattern, the pattern is selectively changed based on facts that the shift map except the cruise shift map is in use and that the accelerator pedal operation amount is decreased from a predetermined judgment operation amount. On this occasion, the judgment operation amounts at times of performing increase judgment and decrease judgment of the acceleration pedal operation can be each set in correspondence with a vehicle speed.

Further, the vehicle gear-shifting control apparatus of the present invention is also characterized in that at a time of selective change of the pattern, judgment is performed based on an engine output torque computed from an accelerator pedal operation amount, instead of judgment of the accelerator pedal operation amount.

Further, the vehicle gear-shifting control apparatus of the present invention is also characterized in that an accelerator pedal opening degree necessary for maintaining a vehicle speed is computed from the set vehicle speed as a computed accelerator opening degree, and in that increase judgment and decrease judgment of the accelerator pedal operation are performed based on comparison between the computed accelerator opening degree and an actual accelerator pedal operation amount.

The vehicle gear-shifting control apparatus of the present invention is also characterized in that an accelerator pedal opening degree necessary for maintaining a vehicle speed is computed from the set vehicle speed as a computed accelerator opening degree, and in that judgment is performed based on comparison between the computed accelerator opening degree and a judgment operation amount at a time of performing decrease judgment of the accelerator pedal operation and comparison between the computed accelerator opening degree and a judgment operation amount at a time of performing increase judgment of the accelerator pedal operation.

Another vehicle gear-shifting control apparatus of the present invention is the vehicle gear-shifting control apparatus performing cruise control which automatically controls output to basically maintain a set vehicle speed set based on a human operation and enables temporary acceleration based on a throttle valve opening degree related to an accelerator pedal operation, and is characterized in that the vehicle gear-shifting control apparatus has: a plurality of shift maps to which a priority ranking is set, the shift maps including a cruise shift map used at a time of cruise control and a shift map used at a time of normal traveling; and a plurality of patterns in which the rankings of the plurality of shift maps are different from each other, wherein, during traveling, the pattern is selectively changed based on the throttle valve opening degree.

### Advantageous Effects of Invention

According to the present invention, it is possible to switch a shift map so that gear-shifting (change of shift speed or gear-shift ratio) of an automatic transmission based on an accelerator pedal operation such as kick-down becomes easy to be performed, optimum gear-shifting in correspondence with a traveling state is enabled, and drivability during cruise control execution can be improved.

### BRIEF DESCRIPTION OF DRAWINGS

FIG. 1 is a diagram depicting a configuration of a vehicle gear-shifting control apparatus according to a first embodiment;

FIG. 2 is a control flowchart of the vehicle gear-shifting control apparatus according to the first embodiment;

FIG. 3 is a chart indicating a priority ranking of shift maps;

FIG. 4 is a chart indicating a judgment operation amount of an accelerator pedal operation amount by a vehicle speed;

FIG. 5 is a chart indicating a judgment time;

FIG. 6 is a chart indicating a judgment opening degree of a throttle valve opening degree by a vehicle speed; and

FIG. 7 is a chart indicating a judgment torque of an engine output torque by a vehicle speed.

### DESCRIPTION OF EMBODIMENTS

Hereinafter, a preferred embodiment of the present invention will be described with reference to the attached drawings.

### First Embodiment

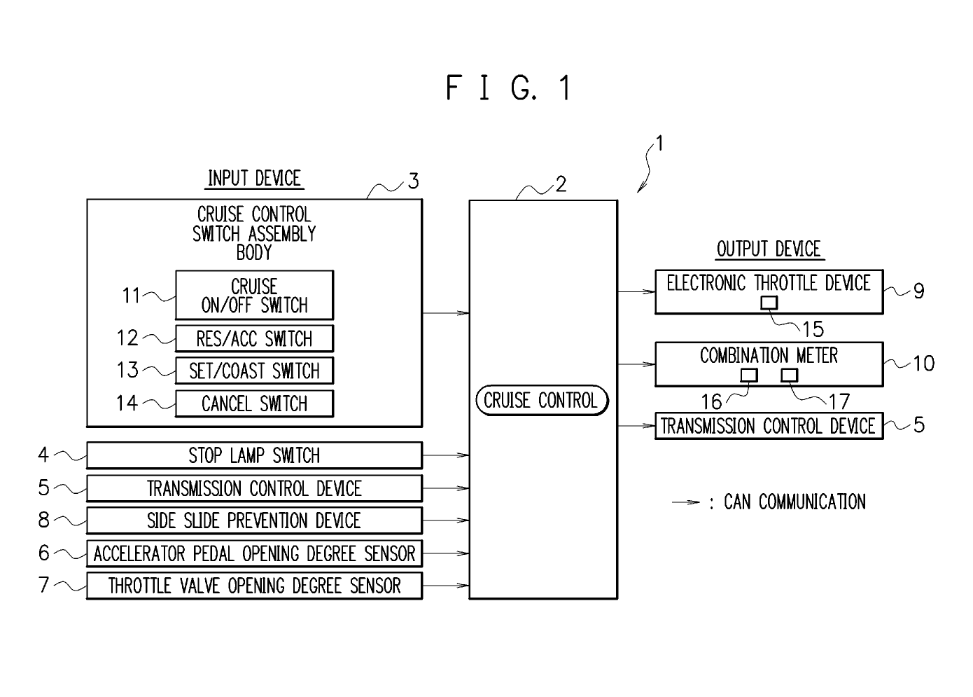

FIG. 1 is a diagram depicting a configuration of a vehicle gear-shifting control apparatus according to a first embodiment. A vehicle gear-shifting control apparatus 1 sets a plurality of patterns in which priority rankings of a plurality of shift maps are different from each other and selectively changes the pattern based on an acceleration operation during traveling, thereby to enable optimum gear-shifting control in correspondence with a traveling state and to improve drivability during execution of cruise control.

In FIG. 1, a reference numeral 1 represents a gear-shifting control apparatus mounted on a vehicle. In the vehicle gear-shifting control apparatus 1, to an input side of an engine control device 2 are connected a cruise control switch assembly body 3, a stop lamp switch 4, a transmission control device 5, an accelerator pedal opening degree sensor 6, a throttle valve opening degree sensor 7, and a side slip prevention device 8. Further, to an output side of the engine control device 2 are connected an electronic throttle device 9, a combination meter 10, and the transmission control device 5.

The engine control device 2 has a cruise control function to automatically adjust engine output so as to maintain a set speed during actual traveling under a condition sufficient for cruise control execution.

The cruise control switch assembly body 3 has a cruise control ON/OFF switch 11 performing an ON/OFF operation of cruise control, an RES/ACC switch 12 which can perform resetting to the set speed before cancellation and performs acceleration when being continuously pressed during cruise control, a SET/COAST switch 13 which can perform setting of a vehicle speed within a predetermined speed range as a set speed and performs deceleration when being continuously pressed during cruise control, and a CANCEL switch 14 which performs cancellation of cruise control when pressed during cruise control.

The stop lamp switch 4 outputs an operation state of a brake pedal to the engine control device 2. If the brake pedal is pressed during cruise control and the stop lamp switch 4 is turned to ON, cruise control is cancelled by the engine control device 2.

The transmission control device 5 has a function to select the shift map to use at present from the provided plural shift maps based on information from the engine control device 2 and a function to set a desired shift speed or gear-shift ratio for an automatic transmission based on the selected shift map and each driving state having been detected, and switches the shift speed or the gear-shift ratio of the automatic transmission by hydraulic control thereby to realize the desired shift speed or gear-shift ratio. The transmission control device 5 outputs shift speed information or gear-shift ratio information and shift position information to the engine control device 2. The cruise control by the engine control device 2 is not performed except when a shift position is at a position “D” or “M”.

The accelerator pedal opening degree sensor 6 outputs an accelerator pedal operation amount to the engine control device 2. The throttle valve opening degree sensor 7 outputs a throttle valve opening degree to the engine control device 2. The side slide prevention device 8 is a device stabilizing a posture of a vehicle at a time of turning steering, and performs control of prevention of understeering or oversteering at a time of turning by integrally controlling an antilock braking system (ABS) which prevents locking of a wheel at a time of braking and a traction control system (TCS) which prevents an idle rotation of a wheel at a time of acceleration.

The electronic throttle device 9 opens/closes a throttle valve by throttle control of the engine control device 2. The engine control device 2 detects a pressing amount (accelerator operation amount) of an accelerator pedal by the accelerator pedal opening degree sensor 6, determines an optimum throttle valve opening degree according to the accelerator pedal opening degree and an engine working state, and drives a throttle motor 15 housed in a throttle body thereby to open/close the throttle valve. It should be noted that throttle valve opening degree information is detected by the throttle valve opening degree sensor 7 and feedbacked to the engine control device 2.

The combination meter 10, having a CRUISE indication light 16 which lights during standby or working of cruise control and a SET indication light 17 which lights during cruise control, performs lighting/lighting-out of the CRUISE indication light 16 and the SET indication light 17 by a signal from the engine control device 2.

The engine control device 2 includes cruise control and a plurality of shift maps, and performs cruise control based on signals from the cruise control switch assembly body 3, the stop lamp switch 4, the transmission control device 5, the accelerator pedal opening degree sensor 6, the throttle valve opening degree sensor 7, the side slip prevention device 8, the electronic throttle device 9, and the combination meter 10, and executes temporary acceleration based on an accelerator pedal operation detected by the accelerator pedal opening degree sensor 6.

Cruise control by the engine control device 2 becomes executable if all the following conditions are fulfilled during engine rotation.

The cruise control execution conditions are as follows:
it is during standby of cruise control (cruise control ON/OFF switch: ON)
it is during traveling within a predetermined speed range of a vehicle speed
a shift position of an automatic transmission is at a position “D” or “M”
a brake pedal is not pressed
a side slide prevention device 8 is not in action, and
cruise control system is sound.

The engine control device 2 has a setting function, an acceleration function, a deceleration function, a cancellation function, and returning function, as functions of the cruise control system.

In the setting function, if the SET/COAST switch 13 is pressed in a state that the execution conditions of cruise control are fulfilled, a vehicle speed at a time of pressing is set as a set vehicle speed and cruise control is started.

In the acceleration function, if the RES/ACC switch 12 is continued to be pressed during cruise control, the vehicle speed is increased and the set vehicle speed is renewed to a vehicle speed at a time that the RES/ACC switch 12 is released. If the RES/ACC switch 12 is press-operated for a short time (for example, equal to or less than 0.4 seconds) during cruise control, the vehicle speed is increased by a constant vehicle speed (for example, about 1.6 km/h) per one press-operation. Further, in the acceleration function, acceleration is temporarily performed based on the accelerator pedal operation detected by the accelerator pedal opening degree sensor 6 during cruise control

In the deceleration function, if the SET/COAST switch 13 is continued to be pressed during cruise control, the vehicle speed is decreased and the set vehicle speed is renewed to a vehicle speed at a time that the SET/COAST switch 13 is released. If the SET/COAST switch 13 is press-operated for a short time (for example, equal to or less than 0.4 seconds) during cruise control, the vehicle speed is decreased by a constant vehicle speed (for example, about 1.6 km/h) per one press-operation.

In the cancellation function, if the CANCEL switch 14 is pressed during cruise control, cruise control is cancelled and it becomes in a cruise control standby state.

In the returning function, in a case that it becomes in the cruise control standby state by a cancellation operation during cruise control, if traveling at a vehicle speed of equal to or more than a lower limit vehicle speed (for example, about 40 km/h) is done, cruise control can be restarted at the set vehicle speed before cancellation by pressing the RES/ACC switch 12.

Cruise control is cancelled by a cancellation operation. The cancellation operation includes manual cancellation, automatic cancellation, and irregular stop. A list of cancellation operations/conditions to lead to cancellation of cruise control is shown below.

(1) Operation/condition of manual cancellation
a cruise control ON/OFF switch: OFF (returning function: −)
a CANCEL switch 14 is pressed (returning function: ◯), and
a brake pedal is pressed (returning function: ◯)

(2) Operation/condition of automatic cancellation
the shift position becomes at a position except “D” or “M” (returning function: ◯)
a vehicle speed becomes equal to or less than a predetermined speed (for example, about 36 km/h) (returning function: ◯)
an engine rotation number becomes equal to or more than an upper limit rotation number (returning function: ◯)
a state in which vehicle speed is lower by a constant value than a vehicle speed set during constant-speed traveling continues (returning function: ◯)
a shift position becomes at a position “M” and equal to or less than a predetermined range (returning function: ◯)
the side slide prevention device 8 is actuated (returning function: ◯)

(3) Operation/condition of irregular stop
abnormality in a cruise control system is detected (returning function: −)

The vehicle gear-shifting control apparatus 1 has the engine control device 2 and the transmission control device 5, and by the engine control device 2, executes cruise control which automatically controls output to basically maintain a set vehicle speed set based on a human operation by the SET/COAST switch 13 and enables temporary acceleration based on an accelerator pedal operation detected by the accelerator pedal opening degree sensor 6, and by the transmission control device 5, executes gear-shifting control to gear-shift (change shift speed or gear-shift ratio) an automatic transmission based on information from the engine control device 2 having a plurality of shift maps.

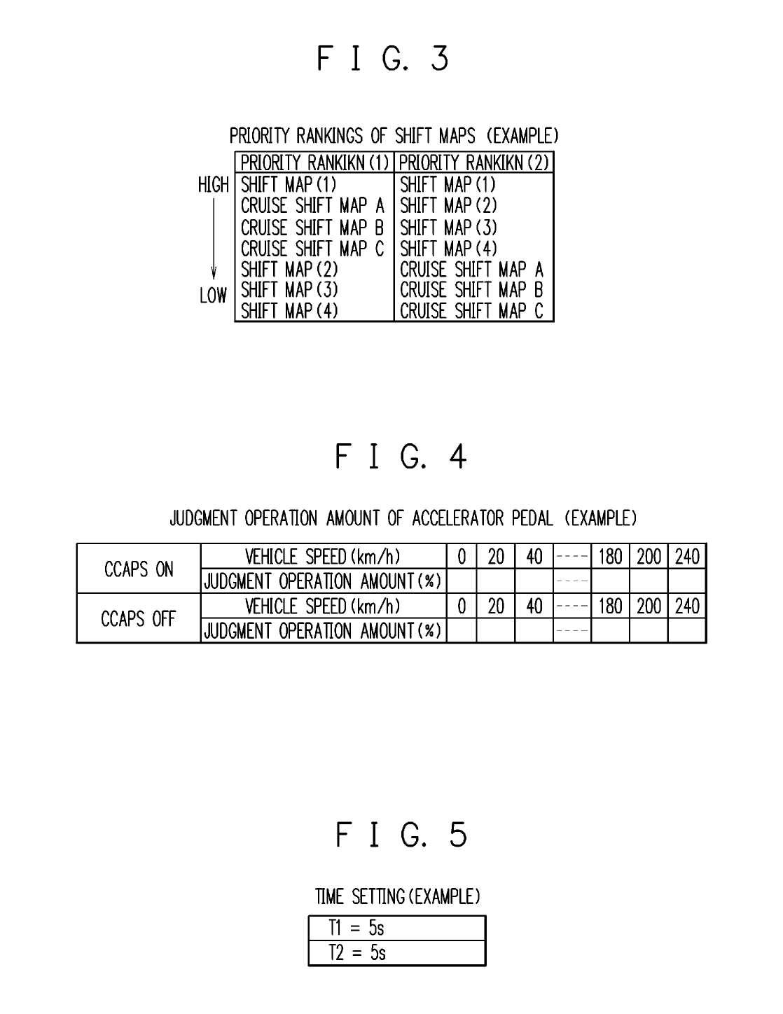

The vehicle gear-shifting control apparatus 1 sets a priority ranking to the plural shift maps including a cruise shift map used at a time of cruise control and the shift map used at a time of normal traveling, and sets a plurality of patterns in which the priority rankings of the plural shift maps are different from each other. In this embodiment, as indicated in FIG. 3, cruise shift maps A, B, and C are set as the cruise shift maps, and shift maps (1) to (4) are set as the shift maps of the normal traveling time. Then, a priority ranking (1) and a priority ranking (2) are set as plural patterns in which the priority rankings of the shift maps are different from each other. The vehicle gear-shifting control apparatus 1 selectively changes the plural patterns during traveling, in this embodiment, two patterns of the priority ranking (1) and the priority ranking (2), based on an accelerator pedal operation humanly operated.

In selectively changing the pattern, the vehicle gear-shifting control apparatus 1 selectively changes the pattern based on facts that the cruise shift map is in use and that the accelerator pedal operation amount is increased from a predetermined judgment operation amount. Further, in selectively changing the pattern, the vehicle speed-shifting control apparatus 1 selectively changes the pattern based on facts that the shift map of normal traveling except the cruise shift map is in use and that the accelerator pedal operation amount is decreased from a predetermined judgment operation amount. Further, the vehicle gear-shifting control apparatus 1 sets the judgment operation amounts at times of performing increase judgment and decrease judgment of the accelerator pedal operation in correspondence with vehicle speeds respectively, as indicated in FIG. 4.

In other words, the vehicle gear-shifting control apparatus 1 has plural shift maps including cruise shift maps A, B, and C used at a time of cruise control and the shift maps (1) to (4) used at a time of normal traveling, and selects the cruise shift map to be used by the automatic transmission for performing gear-shifting during cruise control from the cruise shift maps A, B, and C, based on the pattern of the priority ranking (1) of FIG. 3.

In a case that an acceleration intention occurs in a driver in a state of cruise control according to any one of the cruise shift maps A, B, and C of the priority ranking (1) and the accelerator pedal is pressed, the vehicle gear-shifting control apparatus 1 selects any one of the shift maps (1) to (4) of the normal traveling time based on the pattern of the priority ranking (2) of FIG. 3, if the following condition A is fulfilled:
any one of cruise shift maps A, B, and C is being selected, and
a state in which an accelerator pedal operation amount is increased from a predetermined judgment operation amount (accelerator pedal operation amount≧CCAPS ON) continues for a predetermined judgment time (T1).

In the pattern of the priority ranking (2), since the shift maps (1) to (4) of the normal traveling time except the cruise control maps A, B, and C which are hard to be gear-shifted (kicked down) are preferentially selected, acceleration is possible as the driver intends.

Thereafter, the vehicle gear-shifting control apparatus 1 selects any one of the cruise shift maps A, B, and C in the pattern of the priority ranking (1) again, if the following condition B is fulfilled:
not any one of the cruise shift maps A, B, and C is selected, and
a state in which an accelerator pedal operation amount is decreased from a predetermined judgment operation amount (accelerator pedal operation amount<CCAPS OFF) continues for a predetermined judgment time (T2).

It should be noted that the shift map (1) is supposed to be a shift map used at a time that a specific condition is fulfilled or at a time that an operation is performed, such as a map for a primary manual gear-shifting mode. The predetermined judgment operation amounts (CCAPS ON, CCAPS OFF) are constants which can be set per a vehicle speed as indicated in FIG. 4. In FIG. 4, if an actual vehicle speed is one for which a vehicle speed setting table of a judgment operation amount does not exist (medium vehicle speed), a judgment operation amount corresponding to the vehicle speed is calculated by interpolation calculation. Further, the predetermined judgment times (T1, T2) are, as indicated in FIG. 5, set as T1=5 s (seconds), T2=5 s (seconds), for example.

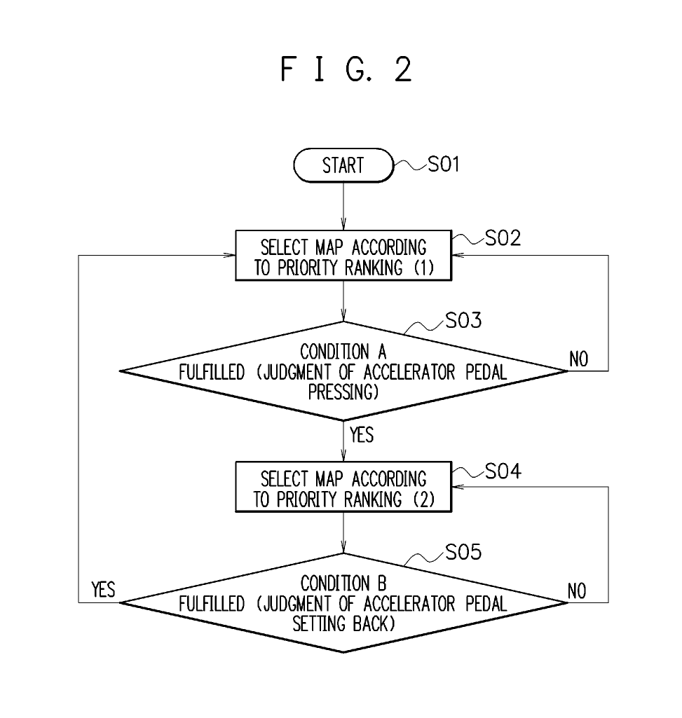

FIG. 2 is a control flowchart of the vehicle gear-shifting control apparatus according to the first embodiment. The engine control device 2 of the vehicle gear-shifting control apparatus 1, during cruise control by fulfillment of the cruise control execution condition, when a program for map selection starts (step S01), selects any one of the cruise shift maps A, B, and C according to the pattern of the priority ranking (1) (step S02), and judges whether or not the condition A (judgment of pressing of accelerator pedal) is fulfilled during cruise control according to any one of the cruise shift maps A, B, and C (step S03).

If judgment of the step S03 is NO, the procedure returns to a processing of the step S02. If the judgment of the step S03 is YES, any one of the shift maps (1) to (4) of the normal traveling time is selected according to the pattern of the priority ranking (2) (step S04), and it is judged whether or not the condition B (judgment of setting back of the accelerator pedal) is fulfilled during cruise control according to any one of the shift maps (1) to (4) (step S05).

If judgment of the step S05 is NO, the procedure returns to a processing of the step S04. If the judgment of the step S05 is YES, the procedure returns to the processing of the step S02. It should be noted that the flowchart in FIG. 2 indicates a flow of only during cruise control and that the flowchart terminates (ends) at an arbitrary timing by unfulfiliment (termination) of the cruise control execution condition.

As described above, the vehicle gear-shifting control apparatus 1, as indicated in FIG. 3, sets the priority ranking to the plural shift maps including the cruise shift map used at the cruise control time and the shift map used at the normal traveling time, sets the plural patterns in which the priority rankings of the plural shift maps are different from each other, and, during traveling, selectively changes the set plural patterns based on the accelerator pedal operation humanly operated.

Thereby, the vehicle gear-shifting control apparatus 1 can switch the shift map so that gear-shifting (change of shift speed or gear-shift ratio) of the automatic transmission based on the accelerator pedal operation such as kick-down becomes easy to be performed, and enables optimum gear-shifting control corresponding to the traveling state, and can improve drivability during cruise control execution.

In selectively changing the pattern, the vehicle gear-shifting control apparatus 1 performs selective change of the pattern based on the fact that the cruise shift map is in use and that the accelerator pedal operation amount is increased from the predetermined judgment operation amount.

Thereby, when the accelerator pedal is press-operated with an acceleration intention during cruise control, the vehicle gear-shifting control apparatus 1 changes the priority ranking of the shift maps smoothly to make change to the normal shift map easy to be performed, so that response can be heightened, enabling improvement of drivability.

Further, in selectively changing the pattern, the vehicle gear-shifting control apparatus 1 performs selective change of the pattern based on the facts that the shift map of the normal traveling except the cruise control map is in use and that the accelerator pedal operation amount is decreased from the predetermined judgment operation amount.

Thereby, when the pressing operation of the accelerator pedal with the acceleration intention is not performed after temporary acceleration during cruise control, the vehicle gear-shifting control apparatus 1 changes the priority ranking of the shift maps smoothly, making change to the cruise shift map easy to be performed, so that return to constant speed traveling can be done.

Further, the vehicle gear-shifting control apparatus 1 sets the judgment operation amounts at times of performing increase judgment and decrease judgment of the accelerator pedal operation in correspondence with vehicle speeds respectively as indicated in FIG. 4.

Thereby, the vehicle gear-shifting control apparatus 1 can perform minute control by differentiating the judgment operation amount of the accelerator pedal operation in correspondence with the vehicle speed and can perform further minute control by differentiating judgment operation amounts of a temporary acceleration start time and a returning time, so that drivability can be further improved.

Hereinafter, a modification example of a vehicle gear-shifting control apparatus 1 will be described, and since a configuration of the vehicle gear-shifting control apparatus 1 is similar to that of the first embodiment, here points of difference from the first embodiment will be mainly described.

### Second Embodiment

In the above-described first embodiment, in the conditions A and B, though the acceleration intention is judged by the condition of the accelerator pedal operation amount in accordance with the condition of the shift map, the accelerator pedal operation amount can be altered to another control element.

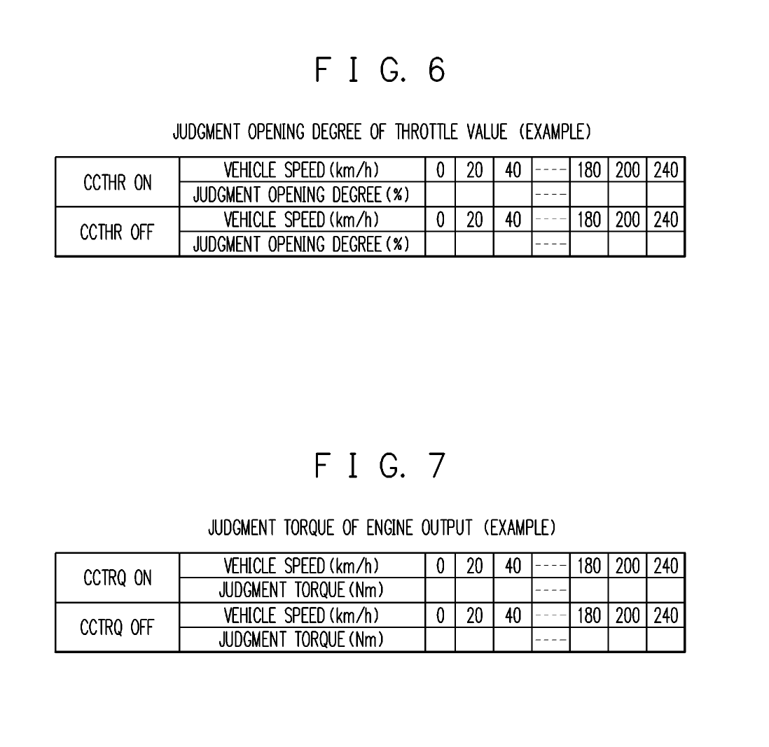

FIG. 6 explains a vehicle gear-shifting control apparatus 1 according to a second embodiment. The vehicle gear-shifting control apparatus 1 according to the second embodiment sets a judgment opening degree of a throttle valve opening degree by a vehicle speed, and in selectively changing a pattern, performs judgment based on a throttle valve opening degree which almost reflects an accelerator pedal operation amount and has a high correlativity, instead of judgment of the accelerator pedal operation amount.

The vehicle gear-shifting control apparatus 1 according to the second embodiment regards, in a condition A, a state in which the throttle valve opening degree is increased from a predetermined judgment opening degree (throttle valve opening degree≧CCTHR ON) as a time when a predetermined judgment time (T1) has continued, and regards, in a condition B, a state in which the throttle vale opening degree is decreased from a predetermined judgment opening degree (throttle valve opening degree<CCTHR OFF) as a time when a predetermined judgment time (T2) has continued.

Thereby, it is easy to apply the vehicle gear-shifting control apparatus 1 according to the second embodiment to a case that a throttle valve opening degree is used as a control parameter.

### Third Embodiment

FIG. 7 explains a vehicle gear-shifting control apparatus 1 according to a third embodiment. The vehicle gear-shifting control apparatus 1 according to the third embodiment sets a judgment torque of an engine output torque by a vehicle speed, and in selectively changing a pattern, performs judgment based on an engine output torque computed from an accelerator pedal operation amount, instead of judgment of an accelerator pedal operation amount.

The vehicle gear-shifting control apparatus 1 according to the third embodiment regards, in a condition A, a state in which the engine output torque is increased from a predetermined judgment torque (engine output torque CCTRQ ON) as a time when a predetermined judgment time (T1) has continued, and regards, in a condition B, a state in which the engine output torque is decreased from a predetermined judgment torque (engine output torque<CCTRQ OFF) as a time when a predetermined judgment time (T2) has continued.

Thereby, it is easy to apply the vehicle gear-shifting control apparatus 1 according to the third embodiment to a case that an engine output torque is used as a control parameter.

### Fourth Embodiment

During cruise control by a vehicle gear-shifting control apparatus 1, an accelerator pedal is not pressed unless a driver has an acceleration intention or the like. In normal control, not pressing an accelerator pedal means closing of a throttle valve. Thus, in a vehicle gear-shifting control apparatus 1 according to a fourth embodiment, an accelerator pedal opening degree necessary for traveling at a set vehicle speed is computed from the set vehicle speed or the like so that a throttle valve opening degree is controlled. By using the accelerator pedal opening degree having been computed (hereinafter, referred to as a “computed accelerator opening degree”), the computed accelerator opening degree and an accelerator pedal opening degree are compared, and such comparison is used in a condition A and a condition B.

The vehicle gear-shifting control apparatus 1 according to the fourth embodiment regards, in the condition A, a state in which the accelerator pedal opening degree is increased from a predetermined computed accelerator opening degree (accelerator pedal opening degree≧computed accelerator opening degree) as a time when a predetermined judgment time (T1) has continued, and regards, in the condition B, a state in which the accelerator pedal opening degree is decreased from the predetermined computed accelerator opening degree (accelerator pedal opening degree<computed accelerator opening degree) as a time when a predetermined judgment time (T2) has continued.

As stated above, the vehicle gear-shifting control apparatus 1 according to the fourth embodiment computes the accelerator pedal opening degree necessary for maintaining the vehicle speed from the set vehicle speed, as the computed accelerator degree, and performs increase judgment and decrease judgment of the accelerator pedal operation based on comparison between the computed accelerator opening degree and an actual accelerator pedal operation amount.

Thereby, the vehicle gear-shifting control apparatus 1 according to the fourth embodiment judges a throttle operation amount for a traveling speed quite accurately and can improve drivability.

### Fifth Embodiment

A vehicle gear-shifting control apparatus 1 according to a fifth embodiment uses the computed acceleration opening degree by the fourth embodiment for vehicle speed control at a time of slope descending. The vehicle gear-shifting control apparatus 1 according to the fifth embodiment computes an accelerator pedal opening degree necessary for maintaining a vehicle speed from a set vehicle speed as a computed accelerator opening degree, and performs judgment based on comparison between the computed accelerator opening degree and a judgment operation amount at a time of performing decrease judgment of an accelerator pedal operation and comparison between the computed accelerator pedal opening degree and a judgment operation amount at a time of performing increase judgment of the accelerator pedal operation.

The vehicle gear-shifting control apparatus 1 according to the fifth embodiment regards, in a condition A, a state in which the computed accelerator opening degree is decreased from a predetermined judgment operation amount (computed accelerator opening degree≦CCAPS OFF) as a time when a predetermined judgment time (T1) has continued, and regards, in a condition B, a state in which the computed accelerator opening degree is increased from a predetermined judgment operation amount (computed accelerator opening degree≧CCAPS ON) as a time when a predetermined judgment time (T2) has continued.

As stated above, when the state in which the computed accelerator opening degree continues to be equal to or lower than an arbitrary threshold value for the predetermined judgment time T1, the vehicle gear-shifting control apparatus 1 according to the fifth embodiment assumes that a deceleration intention exists, and changes a priority ranking of shift maps, following a vehicle speed by using a deceleration map (E/G brake).

Thereby, the vehicle gear-shifting control apparatus 1 according to the fifth embodiment, judging a driving state in which deceleration should be performed, can perform an action of changing the shift map, and is suitable for control at the time of slope descending.

A vehicle gear-shifting control apparatus of the present invention can be constituted by, concretely, a computer system having a CPU, a ROM, a RAM and so on, and is realized as a result that the CPU executes a program. Further, an object of the present invention can be achieved also by providing a storage medium storing a program code of software realizing the aforementioned vehicle gear-shifting control function to a system or a device. In this case, the program code itself read from the storage medium realizes a function of the aforementioned embodiment and the program code itself and the storage medium storing the program code thereof constitute the present invention.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

### INDUSTRIAL APPLICABILITY

A vehicle gear-shifting control apparatus of the present invention enables optimum gear-shifting control in correspondence with a traveling state and can improve drivability during cruise control execution, being able to be applied to various vehicles equipped with automatic transmissions.

1. A vehicle gear-shifting control apparatus performing cruise control which automatically controls output to basically maintain a set vehicle speed set based on a human operation and enables temporary acceleration based on an accelerator pedal operation, the vehicle gear-shifting control apparatus comprising:
a plurality of shift maps to which a priority ranking is set, said shift maps including a cruise shift map used at a time of cruise control and a shift map used at a time of normal traveling; and
a plurality of patterns in which the priority rankings of said plurality of shift maps are different from each other,
wherein, during traveling, said pattern is selectively changed based on an accelerator pedal operation humanly operated.

2. The vehicle gear-shifting control apparatus according to claim 1,
wherein, at a time of selective change of said pattern, said pattern is selectively changed based on facts that the cruise shift map is in use and that the accelerator pedal operation amount is increased from a predetermined judgment operation amount.

3. The vehicle gear-shifting control apparatus according to claim 1,
wherein, at a time of selective change of said pattern, said pattern is selectively changed based on facts that said shift map except the cruise shift map is in use and that the accelerator pedal operation amount is decreased from a predetermined judgment operation amount.

4. The vehicle gear-shifting control apparatus according to claim 2,
wherein the judgment operation amounts at times of performing increase judgment and decrease judgment of the accelerator pedal operation are each set in correspondence with a vehicle speed.

5. The vehicle gear-shifting control apparatus according to claim 3,
wherein the judgment operation amounts at times of performing increase judgment and decrease judgment of the accelerator pedal operation are each set in correspondence with a vehicle speed.

6. The vehicle gear-shifting control apparatus according to claim 1,
wherein at a time of selective change of said pattern, judgment is performed based on an engine output torque computed from an accelerator pedal operation amount instead of judgment of the accelerator pedal operation amount.

7. The vehicle gear-shifting control apparatus according to claim 1,
wherein an accelerator pedal opening degree necessary for maintaining a vehicle speed is computed from the set vehicle speed as a computed accelerator opening degree, and
wherein increase judgment and decrease judgment of the accelerator pedal operation are performed based on comparison between the computed accelerator opening degree and an actual accelerator pedal operation amount.

8. The vehicle gear-shifting control apparatus according to claim 1,
wherein an accelerator pedal opening degree necessary for maintaining a vehicle speed is computed from the set vehicle speed as a computed accelerator opening degree, and
wherein judgment is performed based on comparison between the computed accelerator opening degree and a judgment operation amount at a time of performing decrease judgment of the accelerator pedal operation and comparison between the computed accelerator opening degree and a judgment operation amount at a time of performing increase judgment of the accelerator pedal operation.

9. A vehicle gear-shifting control apparatus performing cruise control which automatically controls output to basically maintain a set vehicle speed set based on a human operation and enables temporary acceleration based on a throttle valve opening degree related to an accelerator pedal operation, the vehicle gear-shifting control apparatus comprising:
a plurality of shift maps to which a priority ranking is set, said shift maps including a cruise shift map used at a time of cruise control and a shift map used at a time of normal traveling; and
a plurality of patterns in which the rankings of said plurality of shift maps are different from each other,
wherein, during traveling, said pattern is selectively changed based on the throttle valve opening degree.
